(19) United States
(12) Patent Application Publication
(10) Pub. No.: US 2013/0311130 A1
(43) Pub. Date: Nov. 21, 2013

(54) PROXIMITY SENSOR SYSTEM

(71) Applicants: Thomas John Horton, Malvern (GB); Paul Antony Manning, Malvern (GB)

(72) Inventors: Thomas John Horton, Malvern (GB); Paul Antony Manning, Malvern (GB)

(73) Assignees: The Secretary of State for Business Innovation and Skills, London (GB); QINETIQ LIMITED, Malvern, Worcestershire (GB)

(21) Appl. No.: 13/982,361

(22) PCT Filed: Feb. 13, 2012
(86) PCT No.: PCT/GB12/00142

§ 371 Date: Jul. 29, 2013

(30) Foreign Application Priority Data
Feb. 14, 2011 (GB) 1102542.6

(51) Int. Cl. G01B 7/14

(52) U.S. Cl. CPC G01B 7/14
USPC 702/142; 702/150

(57) ABSTRACT

A sensor system includes a sensor and processing means adapted to process the signals from the sensor, and to provide a distance measurement or estimate from the sensor to a metallic object of interest, such as a turbine blade. The sensor, typically an eddy current sensor, provides a signal to which the processing means fits a curve, and parameters including pulse width and height are taken from the fitted curve and used in calculating the distance measurement or estimate. Look-up tables may be used to produce the measurement or estimate. Average values of the parameters may calculated to reduce random noise effects and may be subsequently used to produce correction factors to correct instantaneous measurements.

This invention relates to proximity sensors, such as eddy current sensors, and to the processing of signals from such sensors. In particular it relates to the application of such sensors to the measurement of position in relation to objects such as turbine blades and the like.

Gas turbine engines employ sets of turbine blades mounted on rotatable shafts, typically with one or more sets of blades acting as a compressor, feeding air into a combustion chamber, and one or more sets located behind the combustion chamber, acting to power the compressor. Typically there may be between 20 and 200 blades forming a compressor or combustion turbine, and shafts (or spools) may rotate typically at 10,000 revolutions per minute (RPM). To achieve reasonable efficiency it is beneficial in many circumstances for the outside edges of the turbine blades to be within a certain distance from the cowling surrounding the turbine, this being typically between 0.5 and 5 mm. Measurement of this distance while the engine is running is therefore very useful in that the result can be used when adjusting the blade to cowling distance to achieve optimum efficiency. The measurement can also be very useful in detecting (and, if required, compensating for) turbine blade “growth”, which occurs due to the centripetal forces acting on the blades when rotating at high speed, or in detecting overall changes in turbine tip to casing clearance. Defective or incorrectly fitted blades may also be detected, should they unilaterally change height.

Eddy current sensors are commonly in use for making the measurements described above. U.S. Pat. No. 5,942,893 describes such an eddy current sensor that may be used in measuring turbine blade clearance. In use, the sensor is located in the cowling so that it is in close proximity to the outer edge of the turbine blades. The sensors contain one or more coils. The sensors contain a means to create a magnetic field. The field extends into the region through which the objects to be sensed pass. The means to create the field can be either a permanent magnet (for example a rare-earth magnet), or a current passing through one or more of the coils. The field may be either DC or AC. A permanent magnet or a DC current creates a non-uniform DC field. Alternatively, an AC current creates an AC field. Eddy currents are induced in a conducting object as it experiences changes in the magnetic field that surrounds it. In the case of a DC field, the object experiences field changes as it moves through the non-uniform excitation field. The faster the object moves, the greater the rate of change of field, hence higher currents are induced at higher speeds. In the case of an AC illuminating field, the object experiences a changing field whether it is moving or not. Usually the AC frequency is chosen such that it is much greater than the blade passing rate. In this case, the effect of movement through the magnetic field is small compared to the effect of the changing current in the coil.

The eddy currents flowing in the conducting object result in a secondary field. The secondary field can be sensed by various means, such as by detecting the induced voltage in a separate detection coil, or by sensing impedance or apparent inductance changes in the drive coil.

Factors other than distance also affect the measurements made, important ones being changes in the temperatures of the sensor and the blades. Gas turbine engines are subject to extremes of temperature, both hot and cold. It is important therefore to reduce the effects of temperature on the distance reading in such applications. U.S. Pat. No. 4,716,366 describes a differencing technique to reduce temperature effects. U.S. Pat. No. 4,893,079 describes method where temperature correction is performed based on measurements of coil resistance. U.S. Pat. Nos. 7,324,908 and 4,970,670 describes methods wherein a temperature sensor is used to generate a correction factor. U.S. Pat. Nos. 6,479,990, 7,162,384 and 7,323,868 describe alternative techniques.

Other types of proximity sensor exist. These include capacitive types, such as those produced by Tyco Thermal Controls LLC, which measure the capacitance between a sensor and the object being measured, and use the principle that the capacitance will vary inversely with the separation distance.

Yet other types of proximity sensor employ antennas operating at high frequencies to create an electromagnetic field, and measure a disturbance to the field caused by an object entering the field. Such a sensor is described in International patent application, “Rotor Blade Sensor”, publication No. WO2009/034305.

According to a first aspect of the present invention there is provided a proximity sensor system comprising a transducer for detecting proximity to an object, means for receiving a signal from the transducer, and means for processing the received signal, the processing means being adapted to extract, from the received signal, a signal having a form related to the proximity of the object to the transducer, wherein the processing means is arranged to fit a curve to the extracted signal, the curve being chosen to approximate to a form of the signal, and to extract parameters pertaining to a width measurement and a height measurement from the fitted curve, with the parameters providing an indication as to the proximity distance of the object to the transducer.

By fitting a curve to the measured data, and taking measurements from the curve it has been found that a more consistent measurement can be obtained, that still provides the required accuracy of measurement of distance, but which is less susceptible to noise.

Also, under many circumstances (such as when measurements of high speed objects are made), when the received signal is digitised, the number of samples making up the extracted signal is limited, and hence measuring parameters directly from it may lead to significant quantisation errors in both temporal (or equivalently angular) measurements, and in any amplitude measurements made of the signal. The present invention, by fitting a curve to the extracted signal (and extracting desired temporal and/or amplitude parameters from the fitted curve) significantly reduces the effect of such quantisation errors.

The means for processing the received signal may also be arranged to carry out an averaging process whereby two or more extracted signals are averaged together in some manner. This may be done by combining pulse data before the curve fitting is carried out, the curve fitting then being done on combined data. The pulses being combined, comprising two or more pulses, may be time aligned by, for example, subtracting an appropriate time offset from the pulses. A curve fitting process as described herein may then be applied to the combined data. The pulses may relate to different, e.g. consecutive, objects passing the sensor, or alternatively the pulses may relate to multiple instances of the same object passing the sensor.

Averaging of data, such as extracted parameters, following the curve fitting on individual pulses may also be done, but overall requires more computation.

The transducer may optionally be an eddy current sensor. The eddy current sensor may be a single coil sensor, driven with an AC or DC signal, wherein impedance or inductance changes are detected as the coil is driven. Alternatively the eddy current sensor may have one or more coils configured as receive coils, with a DC magnetic field being produced with a permanent magnet. Alternatively, the eddy current sensor may have multiple coils, with one or more driven coils and one or more receive coils.

Alternatively, the transducer may be a capacitive sensor, such as that of the type mentioned above.

Alternatively, the transducer may be a radio frequency sensor that utilises an electromagnetic antenna, such as that of the type mentioned above.

When the transducer is an eddy current sensor, the drive signal may be an AC (alternating current) signal, or a DC (direct current) signal. If a DC current is used then the voltage level of returned signal will vary directly with the distance of the coil to the object, within an operational range, and will increase as the speed increases. If an AC signal is used then the envelope of the signal will be proportional to this distance within the operational range. The operational range is typically between 0.25 mm and 10 mm, with better performance generally being obtained with ranges up to around 7 mm.

If AC is used, then a signal may be extracted by demodulating the signal received from the coil. The demodulation may be a simple envelope detection, or may use a phase coherent approach. If the latter is used then the processing means is preferably arranged to receive a version of the signal sent to the coil, as well as signal received from it. This can act as a clock reference for the coherent demodulation process. The AC signal may be a sine wave. The frequency of the AC signal may be chosen to be compatible with the various components used in the system. Preferably the frequency is high enough to allow several, such as at least twenty, more preferably at least fifty, and still more preferably at least two hundred cycles to occur during the passing of each object of interest, such as a turbine blade. For good results the demodulated data should have enough bandwidth to accurately represent the change in signal as a function of position as the blade passes the sensor. From Nyquist theorem at least two samples per cycle of output bandwidth are required. In practice, because of the desire to filter out the strong signal at 2× the drive frequency which the demodulation process produces from the signal, but preserve the shape of the demodulated pulse, the operation frequency should be rather higher than this. As an example consider an engine with a blade frequency of 10 kHz. Suppose also that a low-pass −3 dB point of around 200 kHz is wanted in the demodulated data and that the 2× drive frequency must be attenuated by 80 dB using a 4^{th} order Bessel filter. In this case a drive frequency of at least 1.5 MHz should be used.

The processing means may be a combination of analogue and digital circuitry. The analogue circuitry may comprise buffer, filters or demodulators, or may comprise merely the input of an analogue to digital converter (ADC). The digital processor may comprise a microprocessor, along with associated memory. The digital processor may have an output to a display, to another indicator (such as an audible alert) or to another system, to which the result of the distance measurement or any of the measured parameters may be passed.

The distance measurement may be compared against a threshold, and an output made from the processor if the separation distance is outside of a predetermined range when compared against the threshold.

The curve used to model the received signal is preferably chosen as being broadly similar in form to the extracted signal. The closer the similarity the better the performance will be in terms of providing an accurate measurement distance, but the skilled person will be aware that some curve forms may involve too much computation to be technically or financially practical on a given system, and so will choose an appropriate curve form based on these factors.

The process of choosing the curve to approximate to the form of the signal is advantageously done in a design or commission phase, wherein test measurements may be taken to ascertain the basic form of the returned signal, and a curve found that is then used in subsequent operations.

The curve may be a function derived from an empirical model of a system on which the present invention is to be used. The empirical model function may be based upon measured signals taken from a real system under test conditions. The function may be produced by, for example, using a look-up table, or by fitting a spline to the measured signals, or by using a Taylor series representation of the measured signal, or by any other suitable means.

The extracted signal may comprise a pulse waveform, with the pulses corresponding to the passing of objects past the transducer. In a turbine application the pulses may correspond to the turbine blade tip passing the transducer. Some turbine blades have a blade tip that is arranged to interface to the tips of the adjacent blades, so that a continuous shroud is formed at the edge. In this case the joints between the tips will still provide a discontinuity as far as generated eddy currents are concerned, and so will still provide a pulse output.

Each pulse corresponds to the passing of an object. It is therefore preferable to isolate each pulse and perform a curve fit on the single pulse. This will provide a measure relating to each individual object. The curve fitting process carried out by the processing means may be carried out using any standard method. For example, the curve may be fitted to the extracted signal using a least squares technique.

The parameters taken from the fitted curve may comprise for example the pulse height, the width at half height (or at any other desired fraction of the pulse height, such as the top or bottom 10%), and the position in time, or other suitable unit, of the pulse peak.

The measured parameters may be converted to a separation distance using, for example, a lookup table. This may be stored in the memory of the processor, and may be initially generated in a calibration step. Other methods of producing the look-up table may be used, such as by mathematical or computer modelling or other analysis. Multiple look up tables may be used, each associated with a different measured parameter.

The proximity distance values may be used as taken from the look-up table, or may instead be processed by, for example averaging the values to reduce the effects of random noise. Systematic errors, such as caused by temperature effects, may also be reduced by calculating correction factors from the averaged values, and applying the correction factor to instantaneous estimates or measurements taken.

The means for providing a drive signal to a coil in the transducer may comprise an oscillator, along with suitable amplification means. The oscillator and amplifier may be located at a suitable distance from the transducer to keep it clear of excess thermal or mechanical stresses, and may be connected to the transducer using wires. The means for receiving the signal from a coil in the transducer (which may be the same coil as is being driven by the driving means) may again comprise wiring from the transducer to the processing means. The driving means and the processing means may be conveniently co-located.

According to a second aspect of the invention there is provided a method for determining distance from a transducer to an object of interest, the transducer being a transducer for detecting proximity, comprising the steps of:
i) arranging the transducer so as to be within range of the object of interest;
ii) receiving a signal from the transducer, and extracting from the received signal a signal having a form related to the proximity of the object to the transducer;
iii) fitting a curve to the extracted signal, the curve being chosen to approximate to a form of the signal
iv) extracting from the fitted curve parameters pertaining to a width measurement and a height measurement, the parameters providing an indication as to the proximity distance of the object to the transducer.

Where the curve has a width, such as, for example, a pulse signal, then the pulse width may advantageously be the parameter extracted. Other parameters that may be extracted include a peak height of the curve, and a position of the peak centre of the curve.

The curve used to approximate to the extracted signal may be derived from a known curve, such as those described above, or may be an empirically derived curve, formed from test data taken from measurements on a representative system. The measurements may be, for example, averaged data from many runs of the representative system, or may be taken from controlled, calibration runs.

The invention will now be described, by way of example only, with respect to the following Figures, of which:

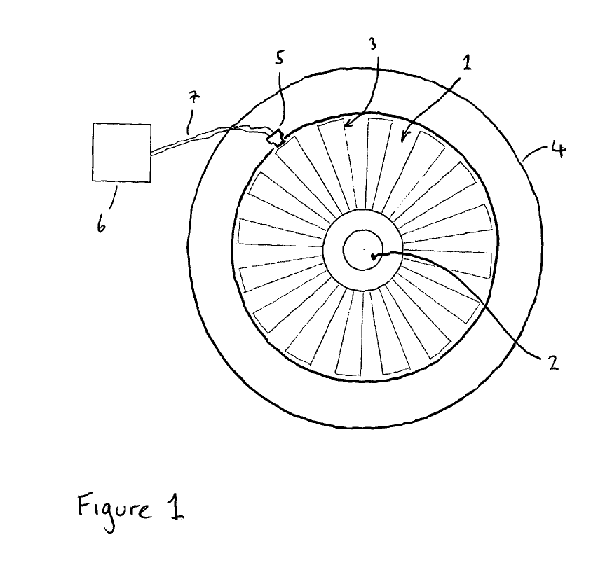

FIG. 1 diagrammatically illustrates a turbine seen front-on, with an eddy current sensor positioned in a cowling with which the present invention may be used;

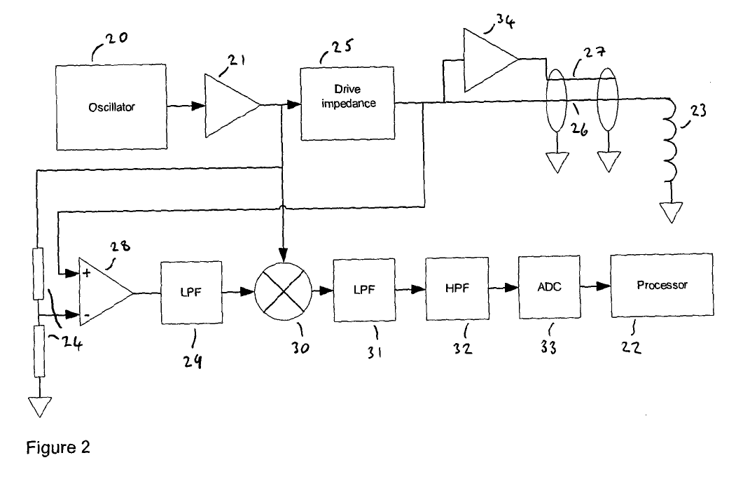

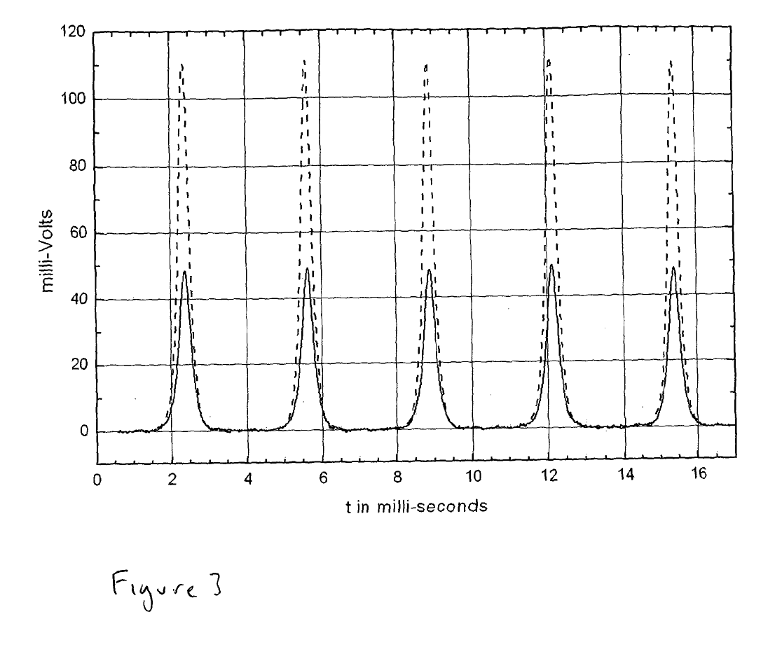

FIG. 2 shows in block diagrammatic form the circuitry used to drive an eddy current coil in a manner suitable for implementation of the present invention;

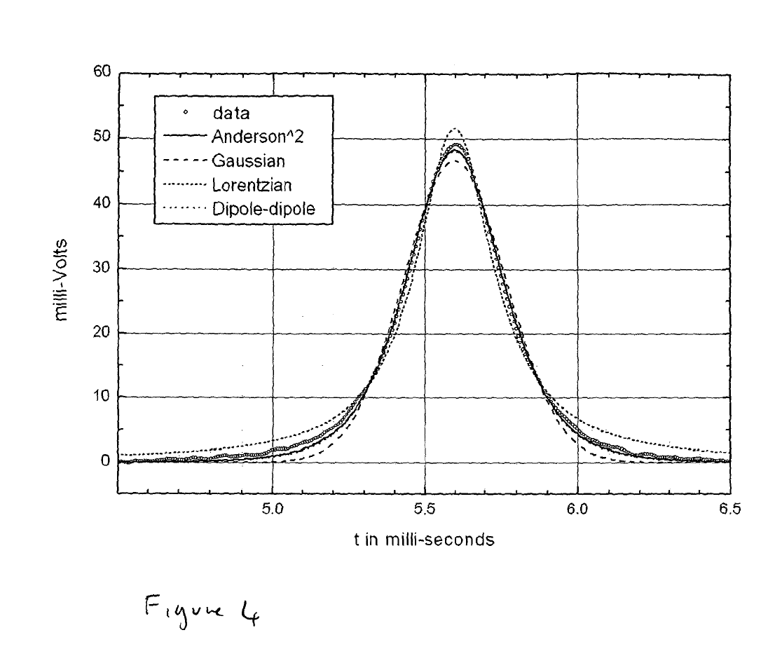

FIG. 3 shows set of pulses measured from a single coil transducer and with which the current invention may be used;

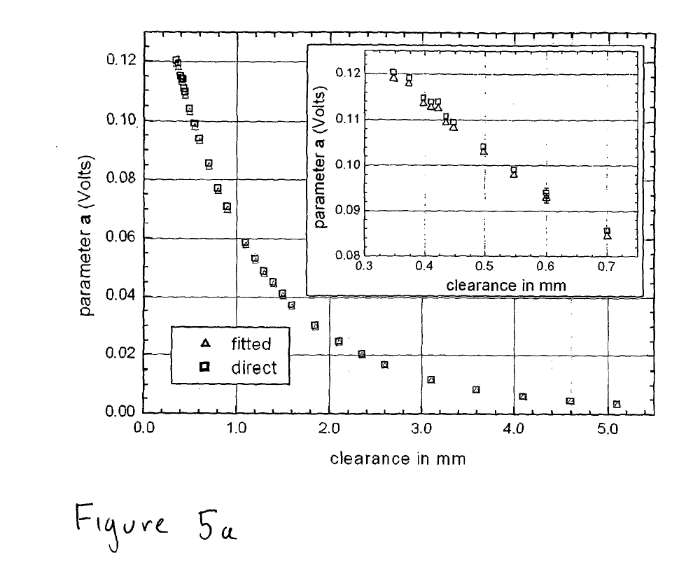

FIG. 4 shows a single measured pulse, and some candidate fitted curve models; and

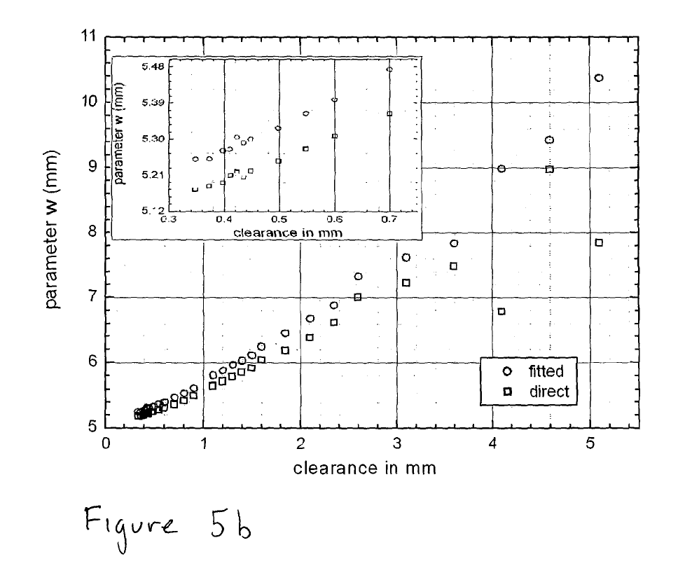

FIG. 5 shows graphs of pulse height and pulse width against clearance distance for both direct measurements and measurements on a fitted curve.

FIG. 1 shows a gas turbine engine seen from the front. Turbine rotor (1) comprises a hub (2), coupled to which, and extending radially therefrom are a set of turbine blades (e.g. 3). In practice there are likely to be more blades than are shown in this simplified representation. Each blade is fixed to the hub, which is able to rotate about the hub centre. A cowling (4) surrounds the turbine rotor and acts as the housing for the engine. As the rotor spins the blades experience a centripetal force, which can make them stretch. This can lead to a risk of them touching the cowling (4), as the clearances are often a few, such as between 1 and 8 millimetres from the tip edge to the cowling. Sensor (5) is an eddy current sensor mounted on the cowling (4), which has a coil or coils that protrude through it to sit just in front of the blade tips as they rotate. Control box (6) provides an energising drive current to the sensor (5) via cable (7), which creates a magnetic field around the coil. Thus as each blade sweeps past the sensor coil through this magnetic field, properties of the magnetic field are altered, due to the presence of the metal, and this change is picked up by the control box to give a reading as described herein and in the prior art documents discussed above. The presence of the target object causes the shape and phase of the magnetic field associated with the coil to change. This can be measured as equivalent to a change in the inductance and a change in the loss (i.e. resistance) of the coil.

FIG. 2 shows in a simplified block diagram form a circuit that may be used to drive a coil so as to implement the present invention. An oscillator (20) provides a sinusoidal waveform to amplifier (21). The frequency of the waveform may be fixed, or may be under the control of processor (22), for applications where the ability to adjust the frequency of operation is desired. The amplifier (21) may have matching circuitry to enable it to drive transducer coil (23) and other associated circuitry more effectively. The output of amplifier (21) is split, with a first path feeding a drive impedance (25) and sensor coil (23), and a second path acting effectively as a phase reference or local oscillator signal in demodulating the signal from the coil. A third path is used, after suitable attenuation (24), to at least partially remove the input signal that is superimposed upon the signal from the coil, to improve the level of recovered, demodulated output from the coil (23).

The drive/tuning impedance (25) is in series with the transducer coil (23). Changes to the transducer coil (23) impedance or inductance caused by electrically conductive objects such as turbine blades coming into close proximity will affect the voltage or current (or both), and these changes can be detected by looking at the voltage across the drive/tuning impedance (25). Preferably the drive/tuning impedance (25) has very similar impedance characteristics to that of transducer coil (23). The impedance 25 may therefore be realised by using an identical component to that of transducer coil (23).

The signal at the output of the drive/tuning impedance, as well as feeding the transducer coil (23) via a coaxial cable (co-ax) (26), also feeds a screen (27) of the co-ax, via screen drive amplifier (34). The screen is driven so that the capacitance between the coil connection and the screen is effectively reduced to near zero. This is mainly to prevent this capacitance (which is in parallel with the sense coil) acting to lower the self-resonant frequency of the coil (23). To avoid the influence of this capacitance on the measurements the sensor should be operated well below this frequency. Capacitive effects are particularly undesirable in applications such as gas turbine engines because in the engine conductive carbon deposits can occur which have a large influence on the varying capacitance between the sense coil and the turbine blade. For this reason it is also desirable to have the ‘earthy’ end of the coil closest to the blade.

As said above, the voltage across the drive/tuning impedance (25) is used to detect the presence or otherwise of the object being in close proximity to the coil (23). The voltage at the output end of impedance (25) is applied to the positive input of a difference amplifier (28). The negative input of the difference amplifier (28) is fed by the voltage on the other side of the drive impedance (25), after being attenuated in attenuator (24). This subtracts off the input signal from the amplifier (21), offsetting it and improving the system dynamic range and increasing sensitivity. The attenuator (24) is adjustable and is used to provide some system adjustment to the amount subtracted. The output from the difference amplifier (28) is low pass filtered in filter (29) and then provided as a first input to demodulator (30).

The second path from the amplifier (21) feeds a second input to demodulator (30), this effectively acting as a phase reference signal. The demodulator (30) comprises a mixer circuit. The output of demodulator (30) is filtered in high, and low-pass filters (31,32) to remove unwanted frequency elements such as the phase reference signal, and any DC component, before being digitised in ADC (33). Subsequent processing is done digitally in processor (22).

The processing described in relation to FIG. 2 provides for the envelope of the demodulated signal to be digitised. This is sufficient in this instance because the drive impedance (25) is well matched to the sense coil (23) impedance so that it acts as an accurate potential divider. If a drive impedance (25) is used that is not so well matched then a complex demodulation process, that uses I-Q (in-phase and quadrature) demodulation techniques to retain both amplitude and phase information of the signal taken from drive/tuning impedance (25) may be employed. This additional information may then be used to produce a suitable signal for implementing the present invention.

A person of ordinary skill in the art would realise that the circuitry discussed in relation to FIG. 2 represents just one of a number of ways of retrieving the information from an eddy current sensor, in a manner suitable for processing using the present invention. Other techniques may be used where they provide a suitable signal.

FIG. 3 is a graph showing a typical set of pulses recorded using an eddy current sensor arranged mounted on a test jig. Note that in some applications the elements passing the sensor can produce positive-going “pulses” and in others they produce negative-going “troughs” in the output of the circuitry. It is assumed herein that if the elements produce troughs, the signal is inverted before further processing. The test jig comprised of a rotatable disk, the disk having radially elongate elements simulating turbine blades in a turbine engine. Two sets of measurements are shown. The first set comprises the taller pulses, shown with a dashed line, and these were recorded with a measured separation between the elements and the eddy current sensor of 2.1 mm, while the smaller peaks, shown with a solid line were recorded with a separation of 4.1 mm. Clearly the height of the peak correlates with the proximity of the element to the sensor. It is not clear from this graph however whether there is a change in shape of the pulses. The shape may provide a more robust means for determining the separation distance rather than just the height of the pulse alone, and the technique of the present invention is used to parameterise the pulses by fitting a model to each pulse, and extract data from the fitted model.

FIG. 4 shows a graph of a single pulse (indicated with the diamond shaped points), along with some candidate pulse models superimposed upon it. The candidate models shown are a scaled Lorentzian (41) (close-dotted line), a Gaussian (42) (dashed line), a dipole-dipole (43) as defined below (sparse dotted line), and a scaled version of the positive only Anderson squared function (solid line). These have been fitted to the pulse using a National Instruments non-linear fit algorithm. The Matlab Isqcurvefit function has been used as an alternative, with similar results.

The Anderson squared function shown is:

$${f}_{A 2} ( t ) = \frac{a}{{[ {( \frac{t - c}{b} )}^{2} + 1 ]}^{3}}$$

The dipole-dipole function is based on a point dipole representation of both the eddy current coil and the elongate elements of the test jig and is given by:

$${f}_{DD} ( t ) = \frac{a}{{4 [ {( \frac{t - c}{b} )}^{2} + 1 ]}^{3}} [ \frac{3}{{( \frac{t - c}{b} )}^{2} + 1} + 1 ]$$

The Gaussian model is given by:

$${f}_{G} ( t ) = a {e}^{- \frac{{( t - c )}^{2}}{2 {b}^{2}}}$$

The Lorentzian is given by:

$${f}_{L} ( t ) = \frac{a}{{( \frac{t - c}{b} )}^{2} + 1}$$

In all of the above, the parameter a is the peak height of the pulse, the parameter b is the width of the pulse, the parameter c is the time of the peak centre. The variable, t is time relative to an arbitrary start time. For turbine blade measurement applications the dimensions of parameters b and c may be converted to angular or distance units for convenience, given knowledge of the rotation speed of the turbine. In particular, the width parameter in dimensions of distance (e.g. around the circumference of a turbine) can be computed using the formula w=sb where s is the speed of the passing elements (e.g. turbine blade tips) and w is the pulse width in dimensions of distance (e.g. units of mm). The signal received from the sensor may be used to compute the speed. In a turbine application, given knowledge of the number of blades N_{b} on the rotor and of the diameter d (in metres) of the rotor, by measuring the frequency f_{b} (in Hz) with which pulses occur, the speed, s (in metres/second), of the blade tips can be calculated using s=πdf_{b}/N_{b}. Alternatively, measuring time T (in seconds) for n blades to pass, use s=πdn/(NT).

Of course, the clearance distance between the coil and the element is not related to the peak centre parameter, c; however, it is used as an indicator of which particular element (e.g. turbine blade) is currently being measured.

Data have been measured using simulated turbine blades on a test rig, using a single coil eddy current sensor. Calculations on the measured data showed that the Anderson squared function was found to produce the best fit, in terms of minimal error, defined as the mean squared difference between the measured data and the model. It can also be seen by eye that the Anderson squared function appears to most closely resemble the pulse.

Thus, for this example the Anderson squared function was chosen. The skilled person will understand that other applications, such as systems employing different coil types, different demodulation systems or different element shapes etc may find different functions, including ones not described above, or an empirically derived model function (as described above), have a better fit.

The pulse waveform shown in FIG. 4 is formed in this example from lots of samples, and so provides an accurate representation of the (analogue) pulse form. There will be many applications, such as measurement of high speed turbines, where much fewer samples of the pulse will be available, due to bandwidth limitations discussed herein. In these circumstances the raw (sampled) data will provide a less accurate representation of the signal, and so will itself be a less reliable indication of proximity. Applying a model function to the samples according to the present invention and extracting relevant parameters from it is likely to improve the accuracy of any proximity measurement under such circumstances. Additionally, combining samples from multiple occurrences of the same object passing the sensor can provide an improved effective sampling rate, which can lead to a better model fit and hence more accurate proximity determination.

An embodiment of the invention records the pulse data using circuitry described in relation to FIG. 2. For each pulse, or for a sub-set of pulses two parameters are used to describe the pulse shape. The parameters are amplitude, a, and width, b. At least two possible methods can be used to obtain the parameters. The first is to measure them directly from the demodulated signals (a being the sample with the highest absolute value, b being the time-interval between the times at which the rising and falling edges of the signal cross a/2). The second is to use a fitting algorithm to fit a model function in a and b (in this example an Anderson Squared function). The width parameter, b, is then converted to dimensions of distance (e.g. mm) and is subsequently denoted w. The parameters a and w are then used to estimate the clearance distance from the sensor coil to the element. FIGS. 5a and 5b show graphs of data taken from a test rig. FIG. 5a shows two plots, the first with parameter a (the pulse height) against clearance distance, with a being taken from the pulse directly (shown with square markers), and the second with a being measured from a fitted Anderson squared curve (triangular markers). The inset graph shows detail at small clearance values. A very good correlation can be seen between the measurement taken from the pulse itself (i.e. direct measurements) and from the fitted model. However, at high temperatures and high vibration levels the pulse tends to become noisy, and hence the direct measurements will become less reliable as an indication of clearance distance. Use of the fitted curve is likely to be more accurate under such circumstances and is therefore preferable. Furthermore, to achieve the desired accuracy without curve fitting to a lesser number of points would require the operating frequency to be extremely high. With reference to the calculation on page 5, points spaced every few 10's of nSec would be ideally used, in turn requiring an operating frequency of well over 10 MHz, to be able to use the sampled data directly and achieve enough signal resolution to measure the blade clearance to within a few 10 s of microns. In practice the practical sense coils have self-resonant frequencies around 10 MHz. In order to be dominated by inductive rather than capacitive effects the coil should be operated well below its self-resonant frequency.

FIG. 5b is a graph showing in a first plot the relationship between w, the width of the curve fitted to the pulse (shown with circular markers), and in a second plot the half-height width of the directly measured pulse (square markers), against clearance distance. The inset graph shows values at small clearance distances. The two plots are not identical because, owing to the form of the model function, the paramater b in the Anderson squared model represents the pulse width at 0.512 of the pulse amplitude. It has been found that this measurement (pulse width) is much less dependent upon the temperature of the coil and element, and so is useful at the high temperatures frequently encountered in turbines. As clearance distance increases the pulse signal becomes smaller and inevitably more noisy. This can be seen in FIG. 5b—at between 4 mm and 5 mm clearance the direct measurements are somewhat erratic. Measurements of the fitted curve are much more stable, and are likely to be more accurate.

Once values for a and w have been obtained, they can be used to estimate the clearance between sensor coil and the passing element. This may be done for example either by reference to a predetermined calibration curve, or by interpolation from a look-up table. These may be themselves produced by, for example, making measurements in controlled conditions where the proximity distance is known, and recording several different measurements at different proximity distances.

The shape of the signal pulses depends on many factors. In addition to the clearance between sensor coil and the passing element, these factors include (but are not limited to) the temperature of the blade and the temperature of the sensor. The amplitude parameter, a, is strongly dependent on clearance, but is also significantly affected by blade temperature, and by resistance changes (which may be thermally induced) in the coil. Consequently thermal variations in the engine can introduce errors in the clearance distance estimated by using amplitude parameter, a, alone. In contrast, the width parameter, w, is only weakly affected by coil and blade temperature. It is more selectively dependent on the clearance. However the dependence is weaker, so random noise affects an estimate of clearance distance estimated using width parameter, w, more significantly than when using amplitude parameter, a.

Another embodiment makes use of the characteristic of the measurement of w being much less affected by changes in coil resistance (but generally having a poorer signal to noise ratio), and the characteristic of the measurement of a generally having a good signal to noise ratio (but relatively poor resilience to changes in coil resistivity, and hence temperature), as shown below.

The technique uses an instantaneous value of a to derive an estimate of the clearance, and then corrects that estimate using average values of w and a.

In more detail, curve fitting is used as described herein, and values for a and b for each pulse, i.e. each passing of the element being detected, are extracted from the fitted curves. Width parameter, b, is converted to dimensions of distance and subsequently denoted w. A look-up table is then used to produce a first estimate of clearance from the value of a, using e.g. a graph similar to that of FIG. 5a to produce an estimate, hₐ, of clearance. A value of clearance derived from an average value of w, using a graph similar to that of FIG. 5b, is then used to derive a correction for coil temperature.

Given a set N of instantaneous pulse amplitude and width measurements aᵢ and wᵢ i.e. measurements derived from each individual passing element, average values of each are produced:

$$Average pulse amplitude \overline{a} = \frac{1}{N} {\sum }_{i = n - N}^{n} {a}_{i}$$

$$Average pulse width \overline{w} = \frac{1}{N} {\sum }_{i = n - N}^{n} {w}_{i}$$

The values ā and w̅ are then used to get corresponding distance values ĥ_{ā} and ĥ _{w̅} respectively, using look-up tables, e.g. FIGS. 5a and 5b as mentioned above. Note that the distance estimates ĥ_{ā} and ĥ _{w̅} using averaged parameters are treated here as equivalent to the averaged distance estimates h̅ₐ and h̅_{w}. In h̅ₐ and h̅_{w} the averaging is performed after the distance estimation. This approximation is valid provided that the look-up tables, e.g. of FIGS. 5a and 5b, are linear on the scale of the scatter in the N values of a and w.

Suppose temperature effects cause ĥₐ, the clearance estimated using parameter a only, to be incorrect so that

ĥₐ=kh_{actual}

where k is an as yet unknown factor and h_{actual} is the actual clearance. The same temperature effects cause negligible error on ĥ_{w}, the clearance estimated using parameter w only. However, ĥ_{w} is subject to random noise with standard deviation σ_{hw}. If an estimate of clearance ĥ _{w̅} is derived from w̅ (averaged), the contribution of noise is diminished by a factor \sqrt{N}. Selecting N large enough means that ĥ _{w̅} tends towards the average of h_{actual} over the same N pulses:

$${\hat{h}}_{\overline{w}} {\to }^{N large } {\overline{h}}_{actual} .$$

The average of k is then approximated by

$$\frac{{\hat{h}}_{\overline{a}}}{{\hat{h}}_{\overline{w}}} = {\to }^{N large } \frac{{\hat{h}}_{\overline{a}}}{{\overline{h}}_{actual}} = \overline{k}$$

The values of ĥ_{ā} and ĥ _{w̅} are then used to correct the instantaneous estimate ĥₐ as follows:

$${\hat{h}}_{corrected} = {\hat{h}}_{a} \frac{{\hat{h}}_{\overline{w}}}{{\hat{h}}_{\overline{a}}}$$

The value for N, i.e. the number of pulses over which the data is averaged, is preferably chosen to span a time that is short enough to enable the averages to track temperature variations of the objects being detected and of the sensing coil. N should also be large enough to ensure that the noise in ĥ _{w̅} is effectively reduced as compared to the non-averaged readings. The value of N will therefore be set according to the environment in which the system is being deployed, but typical figures may be e.g. 10, 100, 1000.

The examples above all use an eddy current sensor as the transducer. It will be appreciated that any form of sensor that produces a signal having characteristics that change according to the proximity between it and an object being measured, and which produces an output that may be modelled either with an analytic function or an empirically derived model, may be used. The examples also show a pulse signal as being that modelled. Other transducers, or other methods of processing the transducer outputs, may present a signal of a form different from a pulse as shown. It may be, for example, a bipolar pulse, a phase change, or a transition from one steady state level to another, such as a rising or falling edge. The present invention may be used with any such signal that may be modelled either with an analytic function or an empirically derived model. Of course, with signal shapes other than pulses, then different signal characteristics, such as rise time, fall time etc. may be those that are taken from any model to measure the proximity data.

The above examples have been disclosed for illustrative purposes, and those skilled in the art will appreciate that various modifications, additions and substitutions are possible, without departing from the scope of the invention as disclosed in the accompanying claims.

1. A proximity sensor system comprising a transducer for detecting proximity to an object, a receiver for receiving a signal from the transducer, and a processor for processing the received signal, the processor being adapted to extract, from the received signal, a signal having a form related to the proximity of the object to the transducer, wherein the processor is arranged to fit a curve to the extracted signal, the curve being chosen to approximate to a form of the signal, and to extract parameters pertaining to a width measurement and a height measurement from the fitted curve, with the parameters providing an indication as to the proximity distance of the object to the transducer.

2. A system as claimed in claim 1 wherein the curve is fitted to the signal using a least squares fit.

3. A system as claimed in claim 1 wherein the parameter to be extracted is the width of the curve at a predetermined height of the curve.

4. A system as claimed in claim 3 wherein a further parameter to be extracted includes the position of the peak centre of the curve.

5. A system as claimed in claim 1 wherein, where the width measurement has units of time, the processor is adapted to measure a speed of the object, and to use the speed to convert the width measurement to units of distance.

6. A system as claimed in claim 1 wherein the curve is chosen from a Gaussian function, a Lorentzian function, a squared Anderson function, a function based on a point dipole representation of the coil and the object, and an empirical model of the signal as the object passes the sensor.

7. A system as claimed in claim 1 wherein a look-up table is used to produce an estimate of proximity distance, the look-up table providing a proximity distance value as an output and having one or more said parameters as input.

8. A system as claimed in claim 7 wherein separate look-up tables are provided for width and height parameter inputs.

9. A system as claimed in claim 1 wherein average values of pulse height and width are used to provide a correction factor for correcting instantaneous proximity distance values.

10. A system as claimed in claim 1 wherein the transducer is an eddy current sensor comprising at least one coil.

11. A system as claimed in claim 10 wherein the system has a signal generator for providing a drive signal to a coil of the eddy current sensor.

12. A system as claimed in claim 11 wherein the drive signal is an AC signal, and the processor is arranged to provide an extracted signal by demodulating the received signal.

13. A system as claimed in claim 10 wherein a single coil is used in the transducer, this being driven by the signal generator, and being used to provide the received signal.

14. A system as claimed in claim 10 wherein two or more coils are used in the transducer, with at least one used as a drive coil and at least one used as a receive coil.

15. A system as claimed in claim 10 wherein the sensor incorporates a permanent magnet for the generation of a DC magnetic field.

16. A system as claimed in claim 1 wherein the transducer is one of a capacitive proximity sensor, and a radio frequency proximity sensor.

17. A method for determining distance from a transducer to an object of interest, the transducer being a transducer for detecting proximity, comprising the steps of:
i) arranging the transducer so as to be within range of the object of interest;
ii) receiving a signal from the transducer, and extracting from the received signal a signal having a form related to the proximity of the object to the transducer;
iii) fitting a curve to the extracted signal, the curve being chosen to approximate to a form of the signal
iv) extracting from the fitted curve parameters pertaining to a width measurement and a height measurement, the parameters providing an indication as to the proximity distance of the object to the transducer.

18. A method as claimed in claim 17 wherein the parameter to be extracted is the width of the curve at a predetermined height of the curve.

19. A method as claimed in claim 18 wherein a parameter to be extracted includes the position of the peak centre of the curve.

20. A method as claimed in claim 17 wherein the curve is chosen from a Gaussian function, a Lorentzian function, a squared Anderson function, a function based on a point dipole representation of the coil and the object, and an empirical model of the signal as the object passes the sensor.
